(19) United States
(12) Patent Application Publication
(10) Pub. No.: US 2014/0011391 A1
(43) Pub. Date: Jan. 9, 2014

(54) ELECTRICAL CONNECTOR WITH IMPROVED SLIDE MECHANISM

(71) Applicants: Yung-Chih HUNG, Jhonghe (TW); Hung-Chi TAI, Jhonghe (TW)

(72) Inventors: Yung-Chih HUNG, Jhonghe (TW); Hung-Chi TAI, Jhonghe (TW)

(73) Assignee: ALLTOP ELECTRONICS (SUZHOU) LTD., Taicang City (CN)

(21) Appl. No.: 13/616,455

(22) Filed: Sep. 14, 2012

(30) Foreign Application Priority Data
Jul. 5, 2012 (CN) 201210230574.9

(51) Int. Cl. H01R 13/64

(52) U.S. Cl. 439/377

(57) ABSTRACT

An electrical connector includes an insulative housing defining a receiving chamber for inserting a test chip, a number of contacts with resilient contacting portions extending into the receiving chamber, a metal shell enclosing the insulative housing and a slide mechanism mounted onto the insulative housing. The slide mechanism includes a slider through which the insulative housing extends and an elastic member compressed between the slider and the metal shell. The slider is slidable with respect to the insulative housing so as to withdraw the test chip from the receiving chamber.

### BACKGROUND OF THE INVENTION

1. Field of the Invention

The present invention relates to an electrical connector, and more particularly to an electrical connector with improved slide mechanism.

2. Description of Related Art

In the current society, there are a large group of diabetic patients. Because the diabetics may easily cause series of complications, in order to avoid such complications, it is a common practice to monitor regularly the blood glucose concentrations of the diabetic patients so as to determine whether the patients have to use drugs. A glucose meter is a very popular apparatus for testing blood glucose concentrations. However, as the blood glucose concentration of a diabetic patient may change at different times of a day, therefore some serious diabetic patients has to test their blood glucose concentrations constantly at different times, such as in the morning, in the afternoon and in the evening.

It is understandable that before testing, a test chip should be inserted into the glucose meter, and once the test of the blood glucose concentration is finished, the test chip should be taken out from the glucose meter. Usually, the glucose meter includes an electrical connector therein for receiving the test chip. Since the electrical connector only provides a receiving slot for receiving the test chip and does not provide any exit mechanism, end users have to use their hands, clips or tweezers to take out the test chip. Obviously, this is inefficient and inconvenient. More importantly, using directly bare hands to take out the test chip may pollute the test chip, where using clips or tweezers may easily damage the test chip.

Hence, an improved electrical connector with slide mechanism for easy withdrawal of a test chip is desired.

### BRIEF SUMMARY OF THE INVENTION

The present invention provides an electrical connector including an insulative housing defining a receiving chamber for inserting a test chip, a plurality of contacts with resilient contacting portions extending into the receiving chamber, a metal shell enclosing the insulative housing and a slide mechanism mounted onto the insulative housing. The slide mechanism includes a slider through which the insulative housing extends and an elastic member compressed between the slider and the metal shell. The slider includes a protrusion extending into the receiving chamber and the insulative housing defines a position slot to receive the protrusion. The slider is slidable with respect to the insulative housing with the protrusion slidable in the position slot so as to withdraw the test chip from the receiving chamber.

The foregoing has outlined rather broadly the features and technical advantages of the present invention in order that the detailed description of the invention that follows may be better understood. Additional features and advantages of the invention will be described hereinafter which form the subject of the claims of the invention.

### BRIEF DESCRIPTION OF THE DRAWINGS

The components in the drawing are not necessarily drawn to scale, the emphasis instead being placed upon clearly illustrating the principles of the described embodiments. In the drawings, reference numerals designate corresponding parts throughout various views, and all the views are schematic.

FIG. 1 is a perspective view of an electrical connector for inserting a test chip in accordance with an illustrated embodiment of the present invention;

FIG. 2 is an exploded view of the electrical connector as shown in FIG. 1;

FIG. 3 is a perspective view of an insulative housing of the electrical connector as shown in FIG. 2;

FIG. 4 is another perspective view of the insulative housing similar to FIG. 3, while taken from a different aspect;

FIG. 5 is a perspective view of contacts of the electrical connector as show in FIG. 2;

FIG. 6 is a perspective view of a slide mechanism of the electrical connector;

FIG. 7 is a perspective view of a metallic shell of the electrical connector as show in FIG. 2; and

FIG. 8 is a perspective view of an organizer for regulating the contacts of the electrical connector.

### DETAILED DESCRIPTION OF THE PREFERRED EMBODIMENT

Reference will now be made to the drawing figures to describe the embodiments of the present invention in detail. In the following description, the same drawing reference numerals are used for the same elements in different drawings.

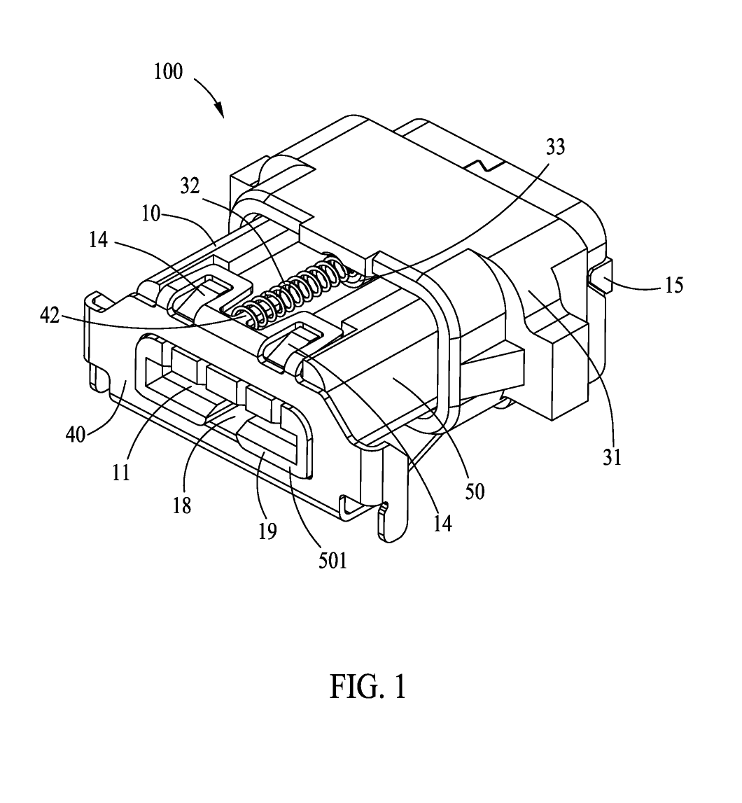

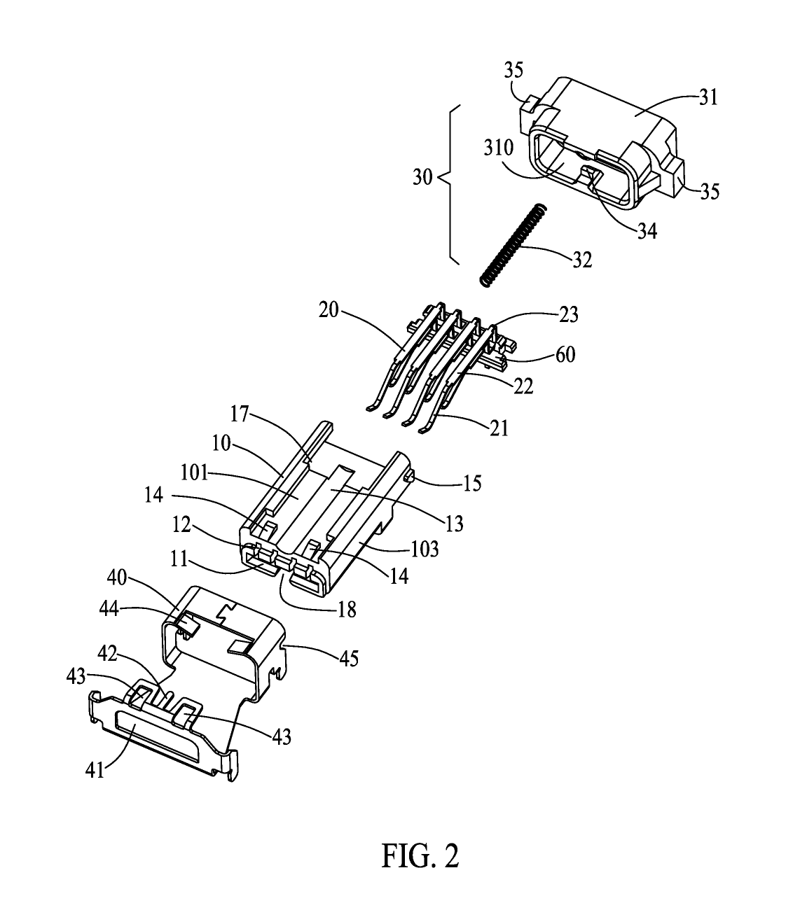

Referring to FIGS. 1 and 2, the present invention discloses an electrical connector 100 applied in a glucose meter (not shown) for inserting and withdrawing a test chip (not shown) which is adapted for testing blood so that end users can understand measurement results. The electrical connector 100 includes a connector body 50, a plurality of contacts 20 retained in the connector body 50 and a slide mechanism 30 slidably mounted onto the connector body 50. According to the illustrated embodiment of the present invention, the connector body 50 includes an insulative housing 10 and a metallic shell 40 enclosing the insulative housing 10. The slide mechanism 30 includes a slider 31 slidable with respect to the insulative housing 10 and a reset elastic member 32 mounted between the connector body 50 and the slider 31. As shown in FIG. 1, the connector body 50 includes a mating surface 501 through which the test chip is inserted.

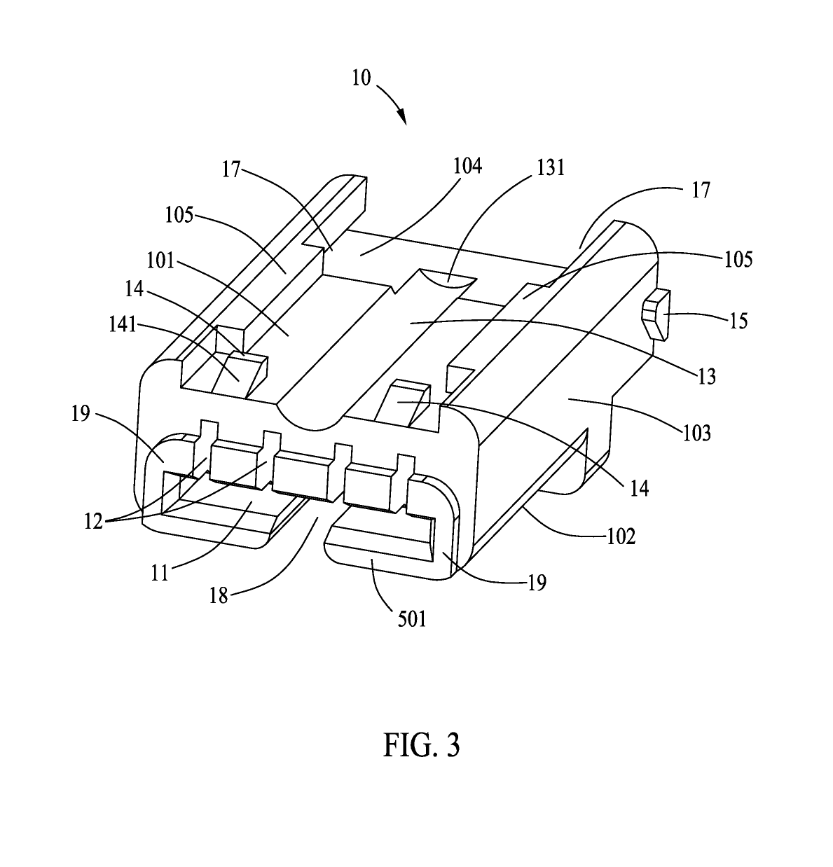

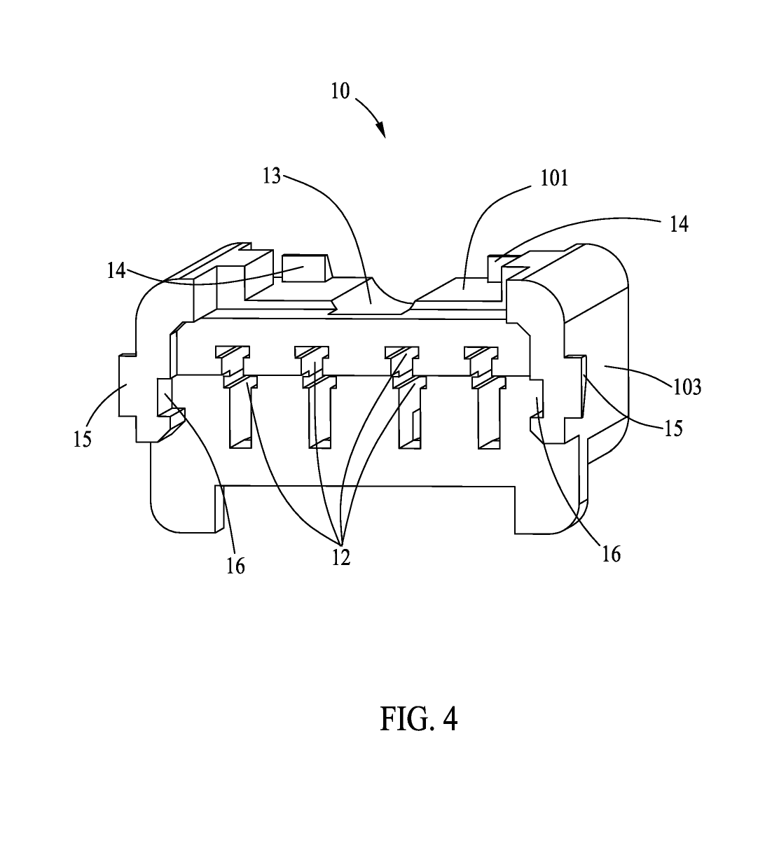

Referring to FIGS. 3 and 4, the insulative housing 10 includes a plurality of peripheral walls including a first top wall 101, a first bottom wall 102 opposite to the first top wall 101 and a pair of first side walls 103 connecting the first top wall 101 and the first bottom wall 102. Besides, a receiving chamber 11 is formed by the first top wall 101, the first bottom wall 102 and the pair of first side walls 103. The receiving chamber 11 extends forwardly through the mating surface 501 for receiving the test chip.

Referring to FIGS. 3 and 4, the first top wall 101 includes a top depression 104, a pair of front locking ribs 14 adjacent to the mating surface 501 and residing in the top depression 104, and a pair of middle protrusions 105 sidewardly extending into the top depression 104 so as to form a pair of recesses 17 at the rear of corresponding protrusions 105. Each locking rib 14 includes an inclined guiding surface 141 for easily assembling the metallic shell 40. Besides, the first top wall 101 further includes a middle guiding slot 13 extending along a front-to-rear direction and a rear restricting wall 131 exposed to the guiding slot 13. The pair of locking ribs 14 are positioned at lateral sides of the guiding slot 13. Furthermore, the first top wall 101 defines a plurality of passageways 12 in communication with the receiving chamber 11 for mounting the contacts 20. The first bottom wall 102 defines a position slot 18 in communication with the receiving chamber 11. Each first side wall 103 includes a rear position protrusion 15 outwardly beyond an outer surface thereof and a locking cutout 16 formed on an inner surface. As shown in FIG. 3, the insulative housing 10 includes a plurality front contractive ribs 19 with the receiving chamber 11 surrounded thereby from a front view.

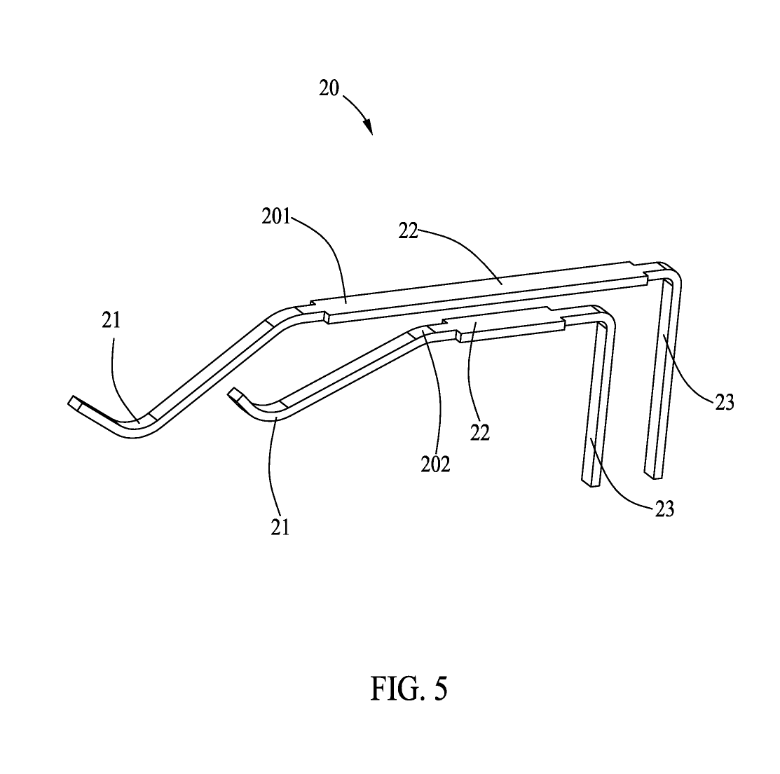

Referring to FIGS. 2 and 5, the contacts 20 includes a first group of contacts 201 and a second group of contacts 202 located essentially below the first group of contacts 201. Configurations of the first group of contacts 201 and the second group of contacts 202 are substantially the same except their proportions. As shown in FIG. 5, each contact 20 includes a resilient contacting portion 21 deformable in the passageways 12 and extending into the receiving chamber 11, a vertical tail portion 23 downwardly extending beyond the insulative housing 10, and a retaining portion 22 connecting the contacting portion 21 and the tail portion 23. The retaining portion 22 is wider than the contacting portion 21 and the tail portion 23 so that each contact 20 can be stably fixed in the insulative housing 10. Since the contacting portions 21 of the first group of contacts 201 are longer than that of the second group of contacts 202, from an integral view, the contacting portions 21 of the contacts 20 are divided into two rows along the front-to-rear direction.

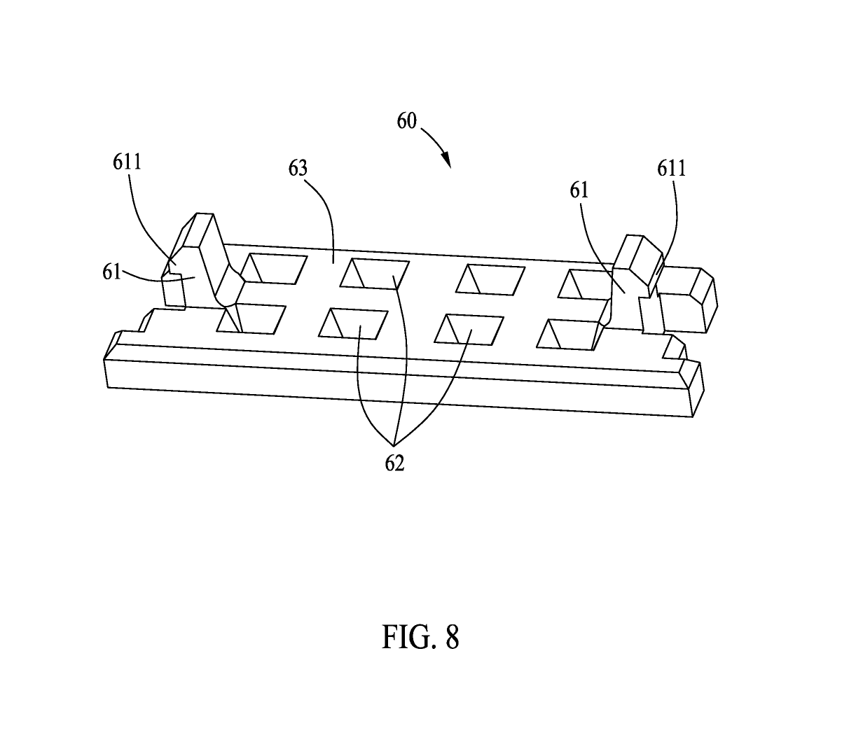

Referring to FIGS. 2 and 8, the electrical connector 100 further includes an organizer 60 locked with the connector body 50 along a bottom-to-top direction. The organizer 60 includes a flat base 63 and a pair of locking arms 61 extending upwardly from lateral sides of the flat base 63. The flat base 63 defines a plurality of through holes 62 through which the tail portions 23 of the contacts 20 extend. Each locking arm 61 includes a latch 611 at a distal end thereof and the latch 611 is locked with corresponding locking cutout 16 of the insulative housing 10 along the bottom-to-top direction.

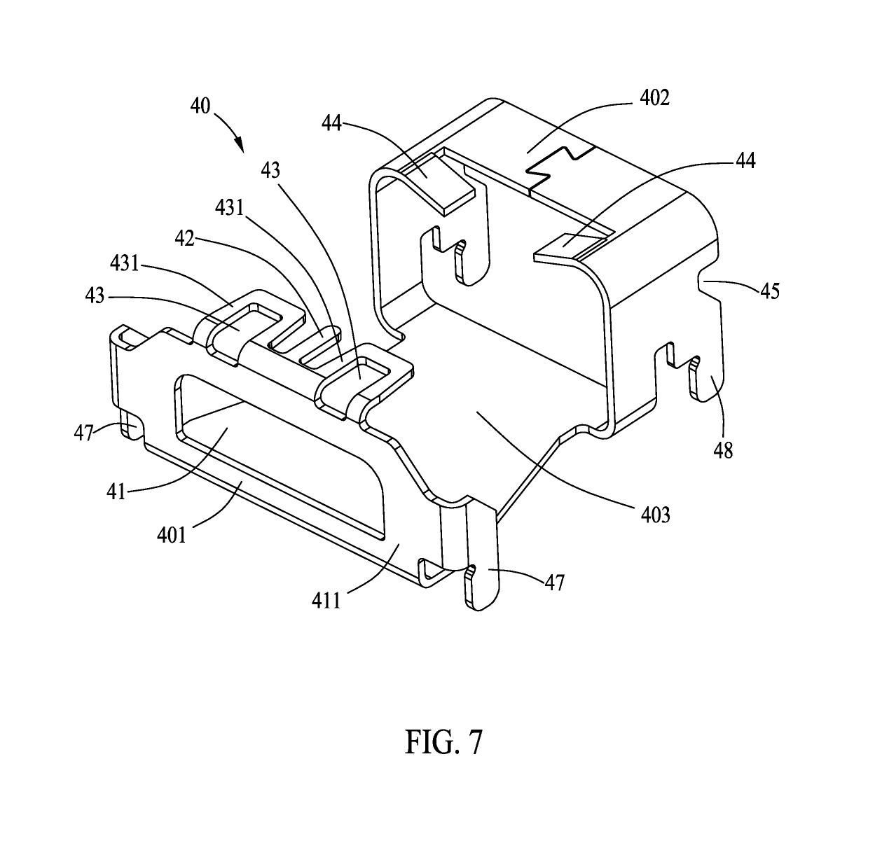

Referring to FIGS. 1, 2 and 7, the metallic shell 40 is fixed to the insulative housing 10 and includes a front cover 401 covering a front side of the insulative housing 10, a rear hollow portion 402 enclosing a rear side of the insulative housing 10 and a connecting portion 403 connecting the front cover 401 and the rear hollow portion 402. The front cover 401 includes a front frame 411 located in a vertical plane, a pair of horizontal extensions 431 bent forwardly from a top edge of the front frame 411, a horizontal position tab 42 between the pair of horizontal extensions 431 and a pair of front mounting legs 47 extending rearwardly and downwardly from lateral sides of the front frame 411. The front frame 411 defines an opening 41 in communication with the receiving chamber 11 for receiving the contractive ribs 19 of the insulative housing 10 for assembly position. Each horizontal extension 431 defines a notch 43 for locking with the locking rib 14 of the insulative housing 10 along the front-to-rear direction under the guidance of the inclined guiding surface 141. The rear hollow portion 402 includes a pair of rear cutouts 45 to receive the position protrusions 15 and a pair of locking tabs 44 extending into the recesses 17 of the insulative housing 10. The locking tabs 44 engage with the middle protrusions 105 so that the metallic shell 40 can be prevented from escaping the insulative housing 10 along a rear-to-front direction. Besides, the rear hollow portion 402 includes a pair of rear mounting legs 48 extending downwardly. The front mounting legs 47 and the rear mounting legs 48 are placed through holes in a PCB (not shown) and soldered to the PCB via only one soldering step passing through a tinning furnace.

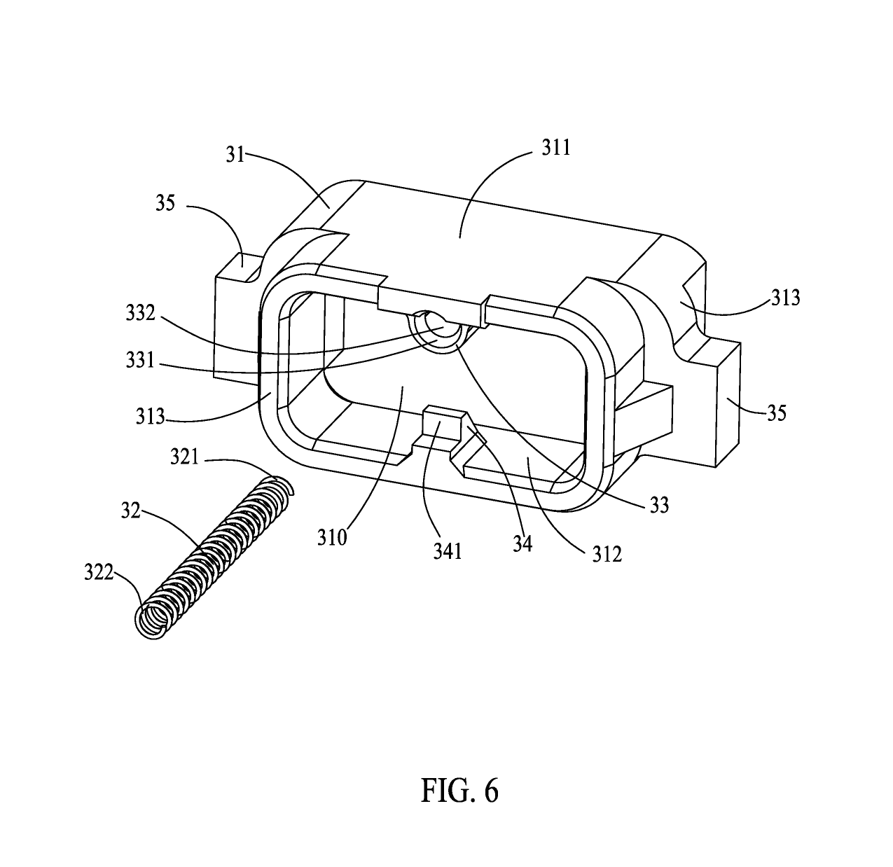

Referring to FIGS. 1 and 6, the slider 31 is hollow and includes a second top wall 311, a second bottom wall 312 and a pair of second side walls 313 connecting the second top wall 311 and the second bottom wall 312. The second top wall 311, the second bottom wall 312 and the pair of second side walls 313 jointly form a hollow cavity 310 through which the connector body 50 is mounted. The second top wall 311 includes a position projection 33 extending along the rear-to-front direction. The position projection 33 defines a column receiving hole 331 and an engaging wall 332 in the receiving hole 331. The position projection 33 is at least partly received in the guiding slot 13. The guiding slot 13 and the position projection 33 include mateable arc-shaped surfaces so that the position projection 33 can be stably slidable in the guiding slot 13. The second bottom wall 312 includes a protrusion 34 extending into the hollow cavity 310. The protrusion 34 is received and slidable in the position slot 18 and further extending into the receiving chamber 11. The protrusion 34 includes a vertical surface 341 for driving the test chip withdrawing from the receiving chamber 11. The second side walls 313 include a pair of lateral protrusions 35 for being driven by an end user so that the slider 31 overcomes the elastic member 32 to make the protrusion 34 slidable in the position slot 18.

Referring to FIGS. 1 and 6, the reset elastic member 32 includes a coiled spring which has a first end 321 received in the receiving hole 331 and restricted by the engaging wall 332 and a second end 322 assembled to the position tab 42. According to the illustrated embodiment of the present invention, the coiled spring is compressed between the position tab 42 and the engaging wall 332 so that the slide mechanism 30 can not be separated from the connector body 50.

According to the illustrated embodiment of the present invention, with such slide mechanism 30 mounted on the connector body 50, when it requires to withdraw the test chip, the end user only needs to push the lateral protrusions 35 of the slider 31. Under this condition, the engaging wall 332 forwardly compresses the coiled spring during the slider 31 moves forwardly. As a result, since the protrusion 34 moves together with the slider 31, the vertical surface 341 of the protrusion 34 ultimately drives the test chip withdrawing from the receiving chamber 11. Once the push force disappears, the coiled spring releases its elasticity and drives the slider 31 backwardly to the original/normal position where the position projection 33 is restricted by the rear restricting wall 131. According to the illustrated embodiment of the present invention, the configuration of the slide mechanism 30 has simple structures and is easy for operating, especially suitable for old patients.

It is to be understood, however, that even though numerous characteristics and advantages of preferred and exemplary embodiments have been set out in the foregoing description, together with details of the structures and functions of the embodiments, the disclosure is illustrative only; and that changes may be made in detail within the principles of present disclosure to the full extent indicated by the broadest general meaning of the terms in which the appended claims are expressed.

What is claimed is:

1. An electrical connector comprising:
a connector body comprising a mating surface, a plurality of peripheral walls and a receiving chamber formed by the peripheral walls, the receiving chamber extending through the mating surface for inserting a test chip, one of the peripheral walls defining a position slot in communication with the receiving chamber;
a plurality of contacts with contacting portions extending into the receiving chamber; and
a slider mounted onto the connector body, the slider comprising a protrusion extending into the receiving chamber, the protrusion being slidable in the position slot so as to withdraw the test chip.

2. The electrical connector as claimed in claim 1, further comprising a reset elastic member mounted between the connector body and the slider.

3. The electrical connector as claimed in claim 2, wherein the reset elastic member includes a coiled spring which is compressed between the connector body and the slider.

4. The electrical connector as claimed in claim 2, wherein the peripheral walls comprise a first top wall, a first bottom wall and a pair of first side walls connecting the first top wall and the first bottom wall, the receiving chamber being formed by the first top wall, the first bottom wall and the pair of first side walls, the top wall defining a plurality of passageways to receive the contacts, the position slot being formed in the first bottom wall.

5. The electrical connector as claimed in claim 4, wherein the connector body comprises an insulative housing and a metallic shell enclosing and fixed to the insulative housing, the peripheral walls being formed on the insulative housing.

6. The electrical connector as claimed in claim 5, wherein the slider is hollow and comprises a second top wall, a second bottom wall and a pair of second side walls connecting the second top wall and the second bottom wall, the second top wall, the second bottom wall and the pair of second side walls jointly forming a hollow cavity through which the connector body is mounted, the protrusion being formed on the second bottom wall and protruding into the hollow cavity.

7. The electrical connector as claimed in claim 6, wherein the second top wall comprises a position projection extending along a rear-to-front direction, the position projection defining a receiving hole and an engaging wall in the receiving hole, the metallic shell comprising a position tab extending along a front-to-rear direction, the reset elastic member comprising a first end received in the receiving hole and restricted by the engaging wall and a second end assembled to the position tab.

8. The electrical connector as claimed in claim 7, wherein the first top wall of the insulative housing defines a guiding slot to at least partly receive the position projection.

9. The electrical connector as claimed in claim 7, wherein the metallic shell comprises a front frame defining an opening in communication with the receiving chamber, the insulative housing comprising a plurality front contractive ribs extending into the opening, the receiving chamber being surrounded by the front contractive ribs.

10. The electrical connector as claimed in claim 9, wherein the first top wall of the insulative housing comprising a locking rib, the metallic shell comprising a horizontal extension bent from the front frame, the horizontal extension defining a notch to fix the locking rib.

11. The electrical connector as claimed in claim 9, wherein the metallic shell comprises a rear hollow portion opposite to the front frame and a connecting portion connecting the front frame and the rear hollow portion, the rear hollow portion enclosing the insulative housing.

12. The electrical connector as claimed in claim 11, wherein each first side wall comprises a position protrusion and the rear hollow portion defines a pair of rear cutouts to receive the position protrusions.

13. The electrical connector as claimed in claim 11, wherein the rear hollow portion comprises a pair of locking tabs and the first top wall of the insulative housing defines a pair of recesses for receiving the locking tabs so that the metallic shell can be prevented from escaping the insulative housing.

14. The electrical connector as claimed in claim 1, wherein the contacting portions of the contacts are divided into two rows along a front-to-rear direction, each contact comprising a tail portion bent downwardly, the electrical connector further comprising an organizer locked with the connector body along a bottom-to-top direction, the organizer defining a plurality of through holes through which the tail portions of the contacts extend.

15. The electrical connector as claimed in claim 1, wherein the slider comprises a pair of lateral protrusions for being driven by an end user so that the protrusion is slidable in the position slot.

16. An electrical connector comprising:
an insulative housing defining a receiving chamber for inserting a test chip;
a plurality of contacts with resilient contacting portions extending into the receiving chamber;
a metal shell enclosing the insulative housing; and
a slide mechanism comprising a slider through which the insulative housing extends and an elastic member mounted between the slider and the metal shell, the slider being slidable with respect to the insulative housing so as to withdraw the test chip from the receiving chamber.

17. The electrical connector as claimed in claim 16, wherein the elastic member includes a coiled spring compressed between the slider and the metal shell.

18. The electrical connector as claimed in claim 16, wherein the insulative housing defines a position slot in communication with the receiving chamber and the slider comprises a protrusion slidable in the position slot so as to withdraw the test chip.

19. The electrical connector as claimed in claim 18, wherein the slider comprises a position projection extending along a rear-to-front direction, the position projection defining a receiving hole and an engaging wall in the receiving hole, the metallic shell comprising a position tab extending along a front-to-rear direction, the elastic member comprising a first end received in the receiving hole and restricted by the engaging wall and a second end assembled to the position tab.

20. The electrical connector as claimed in claim 19, wherein the insulative housing defines a guiding slot to at least partly receive the position projection, the guiding slot and the position projection comprising mateable arc-shaped surfaces.
